(19) United States
(12) Patent Application Publication
(10) Pub. No.: US 2007/0064208 A1
(43) Pub. Date: Mar. 22, 2007

(54) AERIAL SUPPORT STRUCTURE AND METHOD FOR IMAGE CAPTURE

(75) Inventors: Gary Giegerich, Glenside, PA (US); Edmond J. Dougherty, Wayne, PA (US); George R. Simmons III, Haddon Heights, NJ (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: ABLAZE DEVELOPMENT CORPORATION, Wayne, PA (US)

(21) Appl. No.: 11/470,461

(22) Filed: Sep. 6, 2006

Related U.S. Application Data
(60) Provisional application No. 60/714,926, filed on Sep. 7, 2005.
(60) Provisional application No. 60/757,787, filed on Jan. 9, 2006.

(51) Int. Cl. G03B 21/00

(52) U.S. Cl. 353/122

(57) ABSTRACT

An image capturing mechanism for capturing an image of a target includes a support platform, a camera platform suspended from the support platform by a support cable, a camera mounted to the camera platform and a stabilization mechanism associated with the camera. A first end of the support cable is mounted to the support platform and a second end of the support cable is mounted to the camera platform. The stabilization mechanism stabilizes the captured image of the camera. Methods for capturing images utilizing the image capturing mechanism and advertising that may be associated with the device are also disclosed. An advertising medium is mounted to the support platform or the camera platforms to provide noticeable advertising space in a venue where the image capturing mechanism is utilized.

### CROSS-REFERENCE TO RELATED APPLICATIONS

This Patent Application claims priority to U.S. Provisional Patent Application No. 60/714,926, filed Sept. 7, 2005, entitled “Aerial Support Structure and Method for Image Capture” and U.S. Provisional Patent Application No. 60/757,757 filed Jan. 10, 2006, entitled “Aerial Support Structure for Camera”, each of which is incorporated herein by reference.

### BACKGROUND OF THE INVENTION

The present invention is directed to an image capturing mechanism and a method for image capture. More particularly, the image capturing mechanism includes a camera platform suspended from a support platform wherein the camera platform is movable relative to the support platform. The image capturing mechanism is preferably, relatively lightweight and inexpensive to install and operate. The image capturing mechanism may be utilized to perform numerous tasks including capturing still images or photos or for capturing video images. the image capturing mechanism is versatile, relatively inexpensive and safe to operate at a venue.

Several varieties of image capturing mechanisms and methods are well known. For example, mounting a camera to a moving platform to provide various vantage points for capturing images using the camera is known. In addition, suspending a camera from various cables in a venue to provide variable vantage points for capturing images using the camera in a venue is known. Such prior art image capturing mechanisms are typically difficult to construct and employ, are often expensive and may provide a distraction or obstacle for observers at an event in specific types of settings.

It would be advantageous to develop an image capturing mechanism that is relatively inexpensive to construct and employ, is able to be permanently installed in a venue, is able to quickly and safely move about the venue to capture images, provides eye-catching advertising space at the venue, is unobtrusive to viewing an event at the venue, provides stable images and permits sale and editing of captured images from an event.

### BRIEF SUMMARY OF THE INVENTION

Briefly stated, the present invention is directed to an image capturing mechanism for capturing an image of a target. the image capturing mechanism includes a support platform, a camera platform suspended from the support platform by a support cable, a camera mounted to the camera platform and a stabilization mechanism associated with the camera. A first end of the support cable is mounted to the support platform and a second end of the support cable is mounted to the camera platform. The stabilization mechanism stabilizes the captured image or the camera.

In another aspect, the present invention is directed to an image capturing mechanism for capturing images in a venue having an observed area, a seating area and a line of sight. The image capturing mechanism includes a support platform moveable relative to the venue. The support platform is positioned outside of the line of sight. A camera winch is mounted to the support platform and a camera platform is suspended from the support platform by at least one support cable. The at least one support cable is secured to the camera winch. the camera platform is movable at least in a vertical direction relative to the support platform through actuation of the camera winch. A camera is mounted to the camera platform and an advertising medium is mounted to the camera platform or the support platform.

In another aspect, the present invention is directed to an image capturing mechanism for capturing images in a venue having a seating area and an observed area. A line of sight is defined between the seating area and the observed area. The image capturing mechanism includes a support platform moveable relative to the venue outside of the line of sight. A camera platform is suspended from the support platform by a plurality of support cables and is moveable relative to the support platform. A camera is moveably mounted to the camera platform for capturing image so the seating area or the observed area.

In a further aspect, the present invention is directed to a method of capturing images in a venue including a seating area and an observed area with an image capturing mechanism having a support platform, a camera platform suspended from the support platform by a plurality of support cables, a controller and a camera that is moveable relative to the venue. The method includes the steps of positioning the support platform over at least a portion of the observed area, moving the camera platform relative to the support platform into an image capturing position, moving the camera relative to the camera platform to direct the camera onto a target, focusing the camera on the target, capturing an image of the target utilizing the camera, communicating the capture image to the controller and storing the image. The camera platform moves from a generally horizontal position relative to the observed area to a position where the camera platform defines a camera pitch angle relative to the horizontal position.

In yet another aspect, the present invention is directed to an image capturing mechanism for capturing images of an observed area. The image capturing mechanism includes a support platform, a camera platform suspended from the support platform by at least one support cable, a stability mechanism associated with at least one support cable and the camera platform and a camera mounted to the camera platform. A first end of the at least one support cable mounted to the support platform and a second end of the at least one support cable mounted to the camera platform. The camera platform movable relative to the support platform and the stability mechanism stabilizing the camera platform and the camera relative to the observed area.

In another aspect, the present invention is directed to an advertising mechanism mounted within a venue for imparting advertising to individuals at the venue. The advertising mechanism includes a first anchor mounted to the venue, a second anchor mounted to the venue, a transport cable having a first end and a second end, a support platform movably mounted to the transport cable and an advertising medium mounted to the support platform such that the individuals are attracted to the support platform. The first end of the transport cable is secured to the first anchor and the second end of the transport cable is secured to the second anchor.

In an additional aspect, the present invention is directed to an image capturing mechanism for capturing an image of a target. The image capturing mechanism includes a support platform, a camera platform suspended from the support platform by a plurality of support cables and a camera mounted to the camera platform. A first end of each of the support cables mounted to the support platform and a second end of each of the support cables mounted to the camera platform. The support platform and the camera platform are coaxially mounted on a camera axis and each of the plurality of support cables defines a support angle relative to the camera axis.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

FIG. 1 is a front elevational view of an image capturing mechanism in accordance with a first preferred embodiment of the present invention;

FIG. 2 is a top plan view of the image capturing mechanism shown in FIG. 1;

FIG. 2A is a partial, cross-sectional view of the image capturing mechanism shown in FIG. 1, taken along line 2A-2A of FIG. 2;

FIG. 3 is a front elevational view of the image capturing mechanism shown in FIG. 1 mounted within an arena;

FIG. 4 is a more detailed front elevational view of the image capturing mechanism, shown in FIG. 1 mounted in a venue. FIG. 6 is a top plan view of an image capturing mechanism in accordance with a third preferred embodiment of the present invention;

FIG. 5 is a top plan view of an image capturing mechanism in accordance with a second preferred embodiment of the present invention;

FIG. 6 is a top plan view of an image capturing mechanism in accordance with a second preferred embodiment of the present invention;

FIG. 7 is a front elevational view of a camera mounted to a camera mount of the image capturing mechanism shown in FIG. 1; and

FIG. 8 is a schematic block diagram of a control system of the image capturing mechanism shown in FIG. 1.

### DETAILED DESCRIPTION OF THE INVENTION

Certain terminology is used in the following description for convenience only and is not limiting. The words “right”, “left”, “front”, “rear”, “lower”and “upper”designate direction in the drawings to which reference is made. The words “inwardly” and “outwardly” refer to directions toward and away from, respectively, the geometric center of the image capturing mechanism and designated parts thereof. Further, the words “up” and “down” refer to preferred orientations of the above-listed words, derivatives thereof and words of similar import.

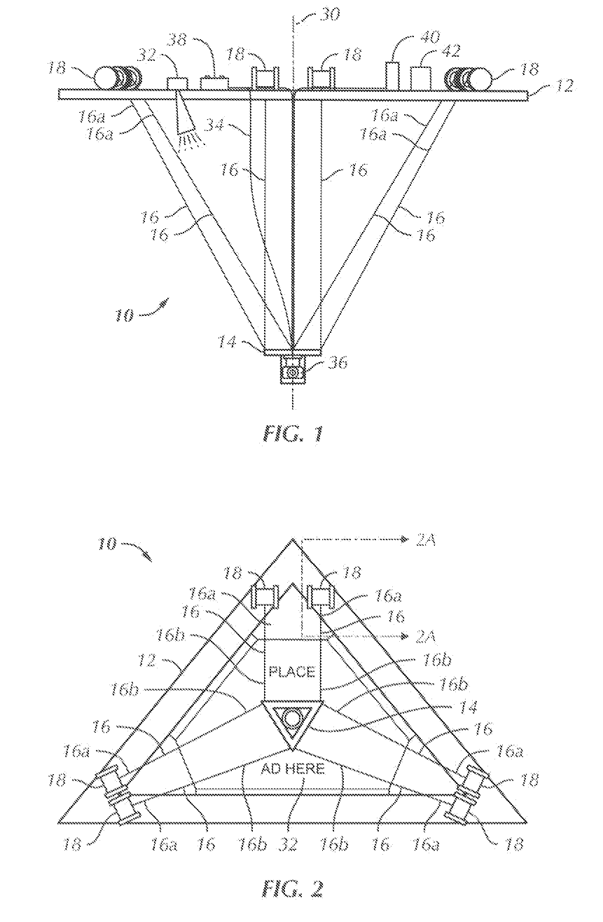

Referring to the drawings in detail, wherein like numerals indicate like elements throughout, there are shown in FIGS. 1-8, first, second and third embodiments of an image capturing mechanism, generally designated 10, 10′, 10″, respectively, in accordance with the present invention. The image capturing mechanism 10, 10′, 10″ is generally utilized to capture images at a venue and to process the images. Like reference numerals are utilized throughout to identify like elements of the first, second and third embodiments of the image capturing mechanism 10, 10′, 10″, while a prime symbol (′) and a double prime symbol (″) are utilized to identify the elements of the second and third embodiments, respectively.

Referring to FIGS. 1-4, the image capturing mechanism 10 is preferably utilized to capture an image of a target in a venue. The image capturing mechanism 10 includes a support platform 12 and a camera platform 14 suspended from the support platform 12 by a support cable 16. In the preferred embodiments, the camera platform 14 is suspended from the support platform 12 by a plurality of support cables 16. The support cables 16 are typically held in tension by the force of gravity due to the suspension of the camera platform 16 from the support platform 12. The image capturing mechanism 10 is not limited to the inclusion of the plurality of support cables 16 or to suspending the camera platform 14 from the support platform 12 by the force of gravity. For example, the camera platform 14 may be suspended from the support platform 12 by a single support cable 16 or the support platform 12 may be mounted under water and the camera platform 14 may be buoyancy fore. Alternatively, the camera platform 14 may be suspended from the support platform 12 by a rigid or elastic member or pole (not shown) that spaces the camera platform 14 from the support platform 12. The support cable or cables 16 may be comprised of a generally rigid pole that is able to carry tensile and compressive loads to support the camera platform 14 and to push items. The camera platform 14 may be spaced from and supported relative to the support platform 12 in nearly any manner that permits the preferred image capturing mechanism 10 to perform its desired functions and is able to withstand the normal operating conditions o the image capturing mechanism 10.

the plurality of support cables 16 in the preferred embodiment are comprised of first, second, third, fourth, fifth and sixth support cables 16. The six (6) support cables provide stability between the support platform 12 and the camera platform 14, permit manipulation of the camera platform 14 relative to the support platform 12, as will be described in greater detail below, and provide safety in suspending the camera platform 14 from the support platform 12 in that even if five or the six support cables 16 are severed, the remaining support cable 16 will continue to support the camera platform 14 relative to the support platform 12. The camera platform 14 is not limited to being suspended from the support platform 12 by the six support cables 16 and may be suspended form the support platform 12 by a lesser number or even a single support cable 16, as was described above, or may be suspended form the support platform 12 by more than six support cables 16. Further, the camera platform 14 may be alternatively spaced and supported relative to the support platform 12.

Referring to FIGS. 1-5, in the first preferred embodiment, the support platform 12 and camera platform 14 are constructed of a generally rigid structural material such as a metallic or a polymeric material. The support platform 12 and camera platform 14 may be constructed of a single component or may be constructed of an assembly of multiple structural components. In the first preferred embodiment, the support platform 12 and camera platform 14 have a generally triangular configuration and in the second preferred embodiment, the support platform 12′ has a generally rectangular configuration. The support platform 12, 12′ and the camera platform 14, 14′ are not limited to having triangular or rectangular configurations and may have nearly any shape or size that is appropriate for a specific venue 28, as will be understood by one having ordinary skill in the art upon reviewing the present disclosure. In addition, the support platform 12 and camera platform 14 are not specifically limited in size and/or shape and may take on nearly any size and/or shape that are appropriate for the specific venue 28.

In the first preferred embodiments, the support platform 12 is constructed of a plurality of bars assembled in a push-pin construction, which is generally simple for a technician to assembled. In addition, the push-pin construction is generally quickly assembled and/or repaired by a technician. As a safety precaution, the push-pin construction of the support platform 12 may be tethered together (not shown) at each assembled joint. The tethers may be connected to one or more of the other assembled portions of the support platform 12 or to the support platform 12 and any related components resting on the support platform 12 typically will not fall or move a significant distance from their intended location. The support platform 12 is not limited to the push-pin constructed assembly or to the inclusion of the tethers and may be constructed of a single structural component or utilize nearly any other assembly technique that would be obvious to one having ordinary skill in the art. However, the push-pin construction assembly and tethering are preferred to simplify assembly and to increase safety of the preferred image capturing mechanism 10.

In the first preferred embodiment, the six support cables 16 each include a first end 16a and a second end 16b. The first end 16a is preferably secured to or mounted to the support platform 12 and the second end 16b is preferably secured to or mounted to the camera platform 14. Six camera winches 18 preferably mount the first end 16a of the support cables 16 to the support platform 12. the preferred six winches 18, similar to the preferred six support cables 16, are not limiting and the camera platform 14 is preferably suspended form the support platform 12 by an equal number of camera winches 18 and support cables 16. However, the camera platform 14 is not limited to being suspended from the support platform 12 by an equal number of camera winches 18 and support cables 16 and may be directly suspending from the camera platform 14 by nearly any number of support cables 16 or a single support cable 16 without the inclusion of the camera winches 18. However, the camera winches 18 are preferred to permit the camera platform 14 to move at least toward and away from the support platform 12.

In the preferred embodiments, the camera winches 18 are each comprised of a single-wrap winch. The camera winches 18 are not limited to being comprised of the single-wrap winches 18 and may be comprised of nearly any mechanism that is able to mount the first end 16a of the support cable 16 to the support platform 12 and, preferably, to move the support cables 16 relative to the support platform 12 to move the camera platform 14 relative to the support platform 12. The camera winches 18 may be mechanically/electrically driven or may be manually driven by an operator located on the support platform 12. In addition, the camera winches 18 are not limited to being mounted to the support platform 12 and may be mounted nearly anywhere in order to move the camera platform 14 relative to the support platform 12. For example, the camera winches 18 may be mounted elsewhere than on the support platform 12 or on the camera platform 14, such as at a ground location and pulleys (not shown) may be mounted to the support platform 12 to aid in movement of the camera platform 14 relative to the support platform 12, as would be understood by one having ordinary skill in the art.

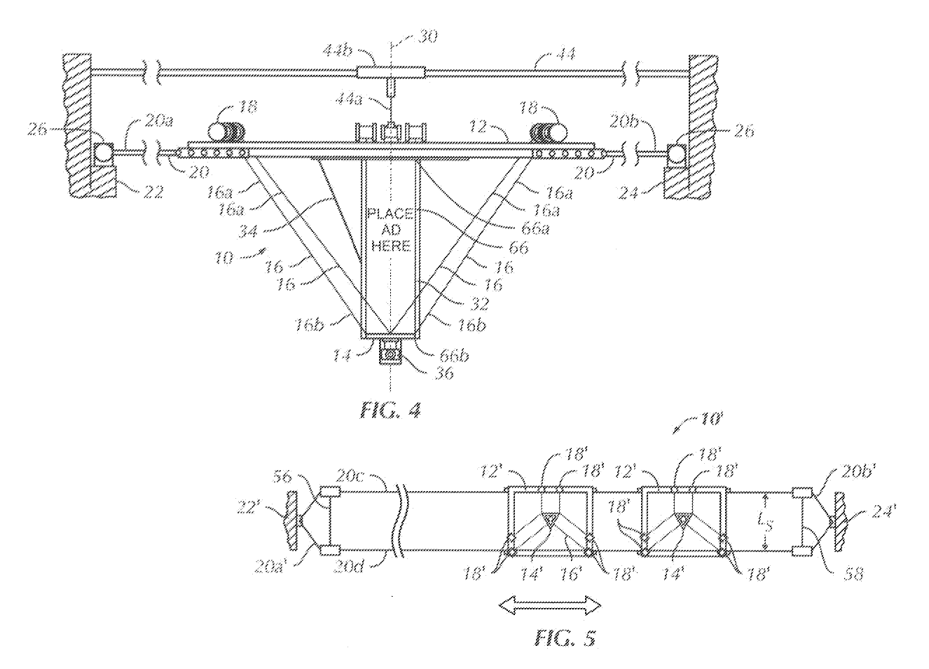

Referring to FIGS. 3 and 4, in the first preferred embodiment, the image capturing mechanism 10 includes a transport cable 20 mounted to the support platform 12. the transport cable 20 includes a third end 20a and a fourth end 20b. The third end 20a is preferably mounted to a first anchor 22 and the fourth end 20b is preferably mounted to a second anchor 24. The support platform 12 is preferably moveable relative to the first and second anchors 22, 24 along the transport cable 20. In the first preferred embodiment, the third end 20a of the transport cable 20 is mounted to the first anchor 22 by a transport winch 26 and the fourth end 20b of the transport cable 20 is mounted to the second anchor 24 by another transport winch 26. The transport winches 26 are preferably single-wrap winches that are actuated to move the support platform 12 toward and away from the first and second anchors 22, 24, respectively.

The support platform 12 is not limited to being mounted to the transport cable 20 or to being moveably mounted along the transport cable 20. In addition, the transport cable 20 is not limited to being mounted at the third and fourth ends 20a, 20b to the transport winches 26. For example, the support platform 12 may be mounted to an arena roof 28a of the venue or arena 28 that the image capturing mechanism 10 is mounted within, as will be described in greater detail below. In addition, the support platform 12 may be mounted to the transport cable 20 by a pulley, rotating wheel or other mechanism that allows the support platform 12 to move to, from and between the third and fourth ends 20a, 20b of the transport cable 20. Moveable mounting the support platform 12 on the transport cable 20 permits the support platform 12 and suspended camera platform 14 to be moved to various locations relative to the venue or arena 28, the advantages of which will become apparent to one having ordinary skill in the art based upon the below description of the image capturing mechanism 10.

Referring to FIGS. 1, 2A, 3 and 4, in the first preferred embodiment, the support platform 12 and camera platform 14 are coaxially mounted on a camera axis 30. The camera axis 30 is preferably a vertical axis that extends through a center of both the support platform 12 and the camera platform 14. Each of the support cables 16 preferably define a support angle Δ relative to the camera axis 30. The preferred angling of the support cables 16 relative to the camera axis 30 provides stiffness and stability to the suspended camera platform 14 relative to the support platform 12. The support angle Δ may be any angle between zero and ninety degrees (0-90°) and typically changes and the camera platform 14 is moved and/or repositioned relative to the support platform 12. In addition, the support angle may be different for several of the support cables 16 in order to modify the position of the camera platform 14 for positioning relative to the support platform 12, as will be described in greater detail below.

The support cables 16 are not limited to creating a specific support angle Δ relative to the camera axis 30. For example, the image capturing mechanism 10 may be configured to include the single support cable 16 that suspends the camera platform 14 from the support platform 12, resulting in the support cable 16 being generally parallel to the camera axis 30 at

Referring to FIGS. 1-5, in the preferred embodiments, the support platform 12 may be comprised of a portion of the venue or the arena 28. For example, the portion of the venue or arena 28 may be comprised of the roof 28a of the venue or arena 28. In such an embodiment (not shown), the support cable 16 would be mounted t the roof 28a and the camera platform 14 would preferably be moveable relative to the roof 28a. In such a preferred embodiment, the six camera winches 18 would be mounted to the roof 28a such that the support cables 16 define the support angle Δ relative to the camera axis 30 to provide stiffness to the camera platform 14 relative to the roof 28a. Mounting the camera winches 18 directly to the roof 28a of the arena 28 results in the image capturing mechanism 10 being at least semi-permanently installed in the arena or venue 28. In such a configuration, the camera platform 14 may be positioned in a storage position close to the roof 28a or in a deployed position by extending the camera platform 14 away from the roof 28a using the winches 18 and support cable 16. In addition, the camera platform 14 may be suspended from some other arena structure, such as a scoreboard 28b (FIG. 3) or nearly any other structure of the venue or arena 28 that permits movement of the camera platform 12 between the storage and deployed positions.

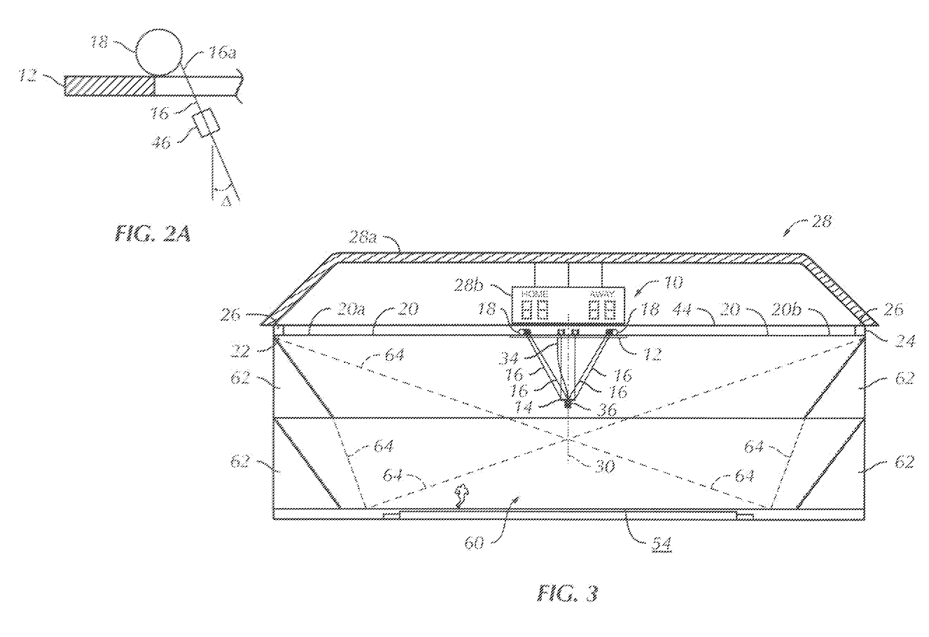

Referring to FIGS. 2, 4 and 8, in the first preferred embodiment, an advertising medium 32 is mounted to the support platform 12 and/or the camera platform 14. the advertising medium 32 may be comprised of, for example, a banner mounted to the support platform 12 with a printed advertisement thereon, signage with a backlit image, a projector that projects images onto a banner, the venue 28, the camera platform 14 or the support platform 12, an electronically controlled sign or nearly any other advertising medium 32 that is able to convey an advertising message to persons, such as patrons within the venue 28. The advertising medium 32 of the preferred embodiment may be constructed of a material that permits flow of air therethrough. For example, a banner 32 may be constructed of a perforated material that permits flow of wind therethrough. The perforated banner permits wind and air to flow therethrough such that the advertising medium 32 does not become a sail that causes the image capturing mechanism 10 to be jostled about when wind or otherwise flowing air is encountered, which may reduce the quality of images captured by the image capturing mechanism 10 due to instability of the cameral platform 14 and/or support platform 12. The advertising medium 32 is not limited to the above-described advertising mechanisms or materials and may be comprised of nearly any feature or item that is able to convey an advertising message.

Referring to FIGS. 1-4, a camera 36 is mounted to the camera platform 14 for capturing images of a desired target. The camera 36 may be a still camera for taking still images, a video camera 36 for taking video images or a combined still and video camera 36 for taking still and video images. The camera 36 is preferably moveably mounted to the camera platform 14 to provide flexibility and adaptability to a user in selecting areas within the venue 28 to target for image capture. In the first preferred embodiment, the camera 36 is able to pan, tilt and zoom for capturing images virtually anywhere in the venue 28 or wherever the image capturing mechanism 10 is mounted to capture images.

Referring to FIGS. 1, 3 and 4, in the first preferred embodiment, a tether cable 34 is comprised of a fiber optic cable that provides signals, such as control information, transmits signals, such as images, and/or provides power to the camera 36. The image capturing mechanism 10 is not limited to inclusion of the tether cable 34 or to the tether cable 34 being constructed of a fiber optic cable. For example, the image capturing mechanism 10 may be constructed without inclusion of the tether cable 34 or may include a structural cable that does not transmit signals and/or power to the camera 36 as the tether cable 34. For example, the tether cable 34 may be constructed of a steel cable that is mounted directly to the support platform 12 at one end and the camera 36 at an opposite end to provide a fail-safe or safety cable in the event that each of the support cables 16 is severed, thereby preventing the camera 36 and camera platform 14 from falling or becoming disengaged from the support platform 12. However, the tether cable 34 is preferably constructed of a fiber optic cable to transmit power and/or signals to the camera 36, because the fiber optic cable is nearly invisible to an individual who is viewing the image capturing mechanism 10 is a preferred venue 28 and is generally efficient in transmitting signals.

Referring to FIGS. 1 and 8, in the first preferred embodiment, a battery 38 is mounted to the support platform 12 to provide power to at least the camera 36. In addition, a controller 40 and radio frequency devices 42 are mounted to the support platform 12 for storing images captured by the camera 36 and transmitting images from the camera 36 to the controller 40, respectively. The radio frequency devices 42 may also be utilized to transmit command signals from the controller 40 to the camera 36 or command signals from the controller 40 to the camera winches 18, transport winches 26 or the advertising medium 32. The image capturing mechanism 10 is not limited to inclusion of the battery 38, the radio frequency devices 42 and/or the controller 40 being mounted to the support platform 12 may not include one or more of these features or may include one or more of these features mounted to the venue 28. In addition, the battery 38, the radio frequency devices 42 and/or the controller 40 may be mounted to other portions of the image capturing mechanism 10 or nearly anywhere inside or outside of the venue 28. However, mounting the controller 40, battery 38 and the radio frequency devices 42 to the support platform 12 positions these features of the preferred image capturing mechanism 10 in a convenient position location for operators of the image capturing mechanism 10.

The image capturing mechanism 10 is not limited to inclusion of the battery 38, as the camera winches 18, transport winches 26, camera 36, advertising medium 32, controller 40 and/or radio frequency devices 42 may be powered by alternative power sources provided by the venue 28 or in nearly any manner that would be obvious to one having ordinary skill in the art. In addition, the radio frequency devices 42 are not required for operation of the image capturing mechanism 10 as the controller 40 may communicate directly or indirectly with nearly any of the components of the image capturing mechanism 10 through hard wiring or some other transmission mechanism, such as infrared. Further, the image capturing mechanism 10 is not limited to inclusion of the controller 40, as the image capturing mechanism 10 may be operated in a completely manual manner. In addition, the controller 40 may be comprised of a home computer located nearly anywhere that communication may be established with the image capturing mechanism 10.

Referring to FIGS. 3 and 4, in the first preferred embodiment, a safety cable 44 is mounted between the first and second anchors 22, 24 above the transport cable 20. The safety cable 44 is preferably secured to the support platform 12 by a safety line 44a and a sleeve 44b that is slidably mounted to the safety cable 44. Inclusion of the safety cable 44, the safety line 44a and the sleeve 44b provides an additional safety measure to the image capturing mechanism 10 in that even if the transport cable 20 were to fail, the support platform 12, camera 14 and related components of the image capturing mechanism 10 would not fall in to the venue 28. Specifically, the safety cable 44, safety line 44a and sleeve 44b is preferably slidable alone the safety cable 44 such that movement of the support platform 12 relative to the safety cable 44 is not inhibited. The image capturing mechanisms 10 is not limited to inclusion of the safety cable 44, the safety line 44a or the sleeve 44b and will function normally without inclusion of these components. However, the safety cable 44 is preferred to provide an additional safety measure to the image capturing mechanism 10 to prevent the suspended components from falling into the venue 28 and potentially injuring individuals who are positioned below the image capturing mechanism 10.

Referring to FIGS. 1-4, the image capturing mechanism 10 of the first preferred embodiment includes a stabilization mechanisms. The stabilization mechanism of the preferred embodiment is comprised at least partially of the support cables 16 that suspend the camera platform 14 from the support platform 12 by extending fro the support platform 12 at the support angle Δ in the first preferred embodiment. The preferred configuration of the six angled support cables 16 provides rigidity and stiffness between the camera platform 14 and the support platform 12 to stabilize the camera platform 14 relative to the support platform 12 and/or the support platform 12 moves relative to the venue 28 on the transport cable 20.

Alternatively, the stabilization mechanism may also be comprised of one or more dampers 46 (FIG. 2A) or dampers and springs (not shown) mounted to the plurality of support cables 16. The one or more dampers 46 and springs may be configured to dampen or diminish vibrations and/or other movements between the support platform 12 and the camera platform 14 to thereby stabilize the camera 36 relative to the support platform 12. The stabilizing mechanism 34 may also be comprised at least partially of control signals sent by the controller 40 to the camera 36, the camera winches 18 and/or the transport winches 26 to limit or control the movement of the support platform 12, the camera platform 14 and/or the camera 36. A gyroscope 48 and/or a flywheel 50 (FIG. 8) may also be utilized in the image capturing mechanism 10 to provide stability or provide signals to the controller 40 to aid in stabilizing the camera 36 relative to the support platform 12 or to stabilizing images captured by the camera 36. The stabilization mechanism is not limited to the above-listed features and/or controls and may be comprised of nearly any mechanism or control feature that is able to stabilize the support platform 12 relative to the camera platform 14, the camera 36 relative to the support platform 12 or, generally, to stabilize images that are captured by the camera 36.

Referring to FIGS. 1-4, the image capturing mechanisms 10 may also be stabilized dynamically by changing the size of the support platform 12. For example, on a windy day, the size or exterior dimensions of the support platform 12 can be enlarged in order to provide additional stability for the camera platform 14 relative to the support platform 12 by modifying the support angle Δ at any given position of the camera platform 14 relative to the support platform 12. The controller 40 may also stabilize the image capturing mechanism 10 on a windy day by receiving wind direction and speed from a wind sensor (not shown) and adjusting the control signals sent to the camera 36, the transport winches 26 and/or the camera winches 18 or by alternatively processing images captured by the camera 36 in various wind conditions to stabilize the images.

The controller 40 may provide stability to the images for the image capturing mechanism 10 in the preferred embodiment by controlling the acceleration and deceleration of the camera winches 18, the transport winches 26 and movement of the camera 36 during various conditions. For example, controlling the rate of acceleration and deceleration of the movement of the camera platform 14 relative to the support platform 12 through the camera winches 18 will typically increase stability by reducing jumpiness or vibration between the camera platform 14 and the support platform 12. In addition, the controller 40 may control the camera winches 18 such that the support cables 16 are constantly in tension to generally reduce jumplines or unwanted movement of the camera platform 14 relative to the support platform 12. Further, the controller 40 may be in communication with various sensors 52 including optical sensors, accelerometers, inertial sensors, inclinometers, anemometers, thermometers, vibration meters, strain gauges or other similar sensors, which are known to those having ordinary skill in the art, that are able to sense movement of the camera 36, camera platform 14 and/or support platform 12 or various environmental conditions such that the controller 40 is able to react to the information to stabilize the image capturing mechanisms 10.

Referring to FIGS. 1-4 and 8, as was describe above, the preferred image capturing mechanism 10 may include an advertising medium 32. The advertising medium 32 may be comprised of a projector 32 (FIG. 1) mounted to the support platform 12 or to the camera platform 14. The projector 32 is preferably in communication with the controller 40 to direct an advertising symbol onto a receiving surface 54 in a venue 28. The projector 32 may be comprised of a colored light display, a laser projector or nearly any other type of projector that is able to project an advertising image onto the receiving surface 54.

Referring to FIG. 5, in the second preferred embodiment, the transport cable 20′ is comprised of a first transport cable 20c and a second transport cable 20d mounted to the support platform 12′. The support platform 12′ is moveable along the first and second transport cables 20c, 20d between the first and second anchors 22′, 24′. The first and second transport cables 20c, 20d are preferably spaced at generally the width of the support platform 12 such that the first and second transport cables 20c, 20d are mounted to opposing sides of the support platform 12′. The support platform 12′ is preferably movable relative to the first and second transport cables 20c. 20d by a pair of winches (not shown) mounted to the support platform 12′. The support platform 12′ is not limited to being movable on the transport cables 20c, 20d or to being movable through the use of the pair of winches mounted to the support platform 12′. For example, the support platform 12′ may be fixed at a specific location on the first and second transport cables 20c, 20d or may be moveable along or with the transport cables 20c, 20d through the use of a linear actuator or other mechanical arrangements, which would be obvious to one having ordinary skill in the art.

The first and second transport cables 20c, 20d of the second preferred embodiment are separated by a first spreader bar 56 mounted proximate the first anchor 22′ and a second spreader bar 58 mounted proximate the second anchor 24′. The first and second spreader bars 56, 58 have a spreader length L_{S} for separating the first and second transport cable 20c, 20d. The first and second spreader bars 56, 58 are preferred to separate the first and second transport cables 20c, 20d to the general width of the support platform 12′. In addition, the inclusion of the first and second spreader bars 56, 58 proximate the first and second anchors 22′, 24′ provide a natural stop for the support platform 12′ in that the support platform 12′ will typically not move to a position closer to the first or second anchors 22′, 24′ than the position of the first or second spreader bars 56, 58. Accordingly, the support platform 12′ will typically not impact the first or second anchors 22′, 24′, thereby potentially damaging the image capturing mechanism 10′.

The second preferred embodiment of the image capturing mechanism 10′ also shows that at least two support platforms 12′ may be mounted to the first and second transport cables 20c, 20d to move between the first and second anchors 22, 24. The inclusion of the two support platforms 12′ for movement on the transport cables 20c, 20d provides additional camera angles for an operator along the transport cables 20c, 20d when compared to the inclusion of only a single support platform 12′. The inclusion of multiple support platforms 12′. camera platforms 14′, and cameras 36′ may be employed in any of the first, second or third embodiments of the image capturing mechanism 10, 10′, 10″ to increase available camera angles for an operator.

Referring to FIGS. 1, 3, 5 and 8, the inclusion of multiple support platforms 12, camera platforms 14, cameras 36 and other associated components on the transport cable 20 is preferably controlled by the controller 40 such that the multiple support platforms 12, camera platforms 14 and/or cameras 36 do not impact each other during use. For example, the controller 40 may be programmed to prevent impacts between the camera platforms 14 on the transport cables 20 and to prevent accelerations of the support platforms 12 towards each other such that the camera platforms 14 or cameras 36 do impact each other during use. The controller 40 is not limited to controlling the image capturing mechanisms 10 such that they do not impact upon each other during use. For example, the image capturing mechanisms 10 may be outfitted with springs, bumpers or other mechanisms that prevent the various components form impacting each other during use or may be constructed in such a manner that they are robust enough to withstand occasional impacts during use.

Referring to FIG. 3, in the first preferred embodiment, the image capturing mechanism 10 is mounted in the venue 28, typically a sporting arena 28. The arena 28, preferably includes an observed area 60, a seating area 62 and a line of sight 64 from the seating area 62 to the observed area 60. The lines of sight 64 shown in FIG. 3 depict certain of the extreme lines of sight 64 from the seating area 62 of the preferred arena 28. The support platform 12 is preferably mounted outside of each line of sight 64 or is programmed to prevent movement into each of the lines of sight 64 of the venue or arena 28. Accordingly, in the first preferred embodiment, persons, such as patrons in the seating area 62 are able to observe events or other activates occurring in all portions of the observed area 60 within their line of sight 64 without their view being obstructed by the support platform 12. It is preferred that the support platform 12 does not extend into any of the patron's line of sight 64 to obstruct views of the observed area. In the first preferred embodiment, the support platform 12 is mounted between the first and second anchors 20, 24 and moveable on the transport cable 20 such that regardless of where the support platform 12 is positioned on the transport cable 20, the support platform 12 does not obstruct any of the observer's lines of sight 64.

In the first preferred embodiment, mounting the support platform 12 out of the line of sight 64 of the observers in the seating area 62 prevents obstructing the patron's view of the observed area 60 but also draws attention to the support platform 12 when the support platform moves along the transport cable 20. Accordingly, persons, such as patrons in the seating area 62 will be drawn to the movement of the support platform 12 and to any of the advertising mediums 32 that may be mounted to the support platform 12, projected onto the receiving surface 54 or otherwise associated with the preferred image capturing mechanism 10. Accordingly, the image capturing mechanism 10 of the first preferred embodiment generally does not obscure a patron's line of sight 64 to the observed area 60 but also draws attention to itself and the advertising medium 32.

In the preferred embodiments, the advertising medium 32 may be comprised of a message board that permits continuous modifications of an advertisement on the advertising medium 32. The message board (not shown) is preferably in communication with the controller 40 such that the controller 40 is able to modify the advertisement on the message board at predetermined time periods. The message board may be mounted to the support platform 12, camera platform 14, camera 36 or nearly anywhere along or on the image capturing mechanism 10. The structure and operation of the message board is generally well known to one having ordinary skill in the art.

Referring to FIG. 4, the advertising medium 32 may also be comprised of a banner 66 having a first edge 66a and a second edge 66b. The first edge 66a is preferably mounted to the support platform 12 and the second edge 66b is preferably mounted to the camera platform 14. In operation, the camera platform 14 may initially be positioned in a storage position such that the banner 66 is stored and cannot be viewed by persons, such as patrons in the seating area 62. During use, when the camera platform 14 is extended on the support cables 16 relative to the support platforms 12, the banner 66 unfurls as the second edge 66b extends away from the first edge 66a to display the entire advertising banner 66. The banner 66 may also be configured such that the second edge 66b releases from the camera platform 14 while a certain action, such as game play, is occurring in the observed area 60 and is reattached to the camera platform 14 when certain other activities are taking place on the observed area 60, such as during time outs of game play.

Referring to FIGS. 1-8, in the preferred embodiments, the camera 36 may be utilized to capture images in the observed area 60, the seating area 62, nearly anywhere else within the venue 28 or anywhere outside the venue 28 within a line of sight of the camera 36.

Referring to FIGS. 3 and 8, in the first preferred embodiment, one of the sensors 52 may include a motion sensor that is mounted to the camera 36, camera platform 14, support platform 12 or nearly anywhere else on the image capturing mechanism 10. The motion sensor is preferably in communication with the controller 40 to send a signal to the controller 40 when the motion sensor senses motion. The controller 40 may direct the camera 36 to focus on a motion area where motion was sensed by the motion sensor based upon the signal. Utilization of the image capturing mechanism 10 with the motion sensor is preferably utilized for security in venues 28 or in nearly any location where mechanical security may be desirable. For example, when a venue or arena 28 is closed, motion sensors may be directed towards exits or entrances of the venue 28 such that the camera 36 focuses and captures motion at the entrances or exits, potentially intruders, when the venue 28 is closed. Such security applications for the image capturing mechanism 10 permit providing security without personnel having to be present at the venue 28, while also providing video and/or still images of potential intruders. The images may then be transmitted by the radio frequency device 42 or another related transmitting device, such as bard wiring or laser transmission, to a security officer who is able to assess any threat without being physically present at the venue 28.

Referring to FIGS. 1 and 3, in the first preferred embodiment, the camera platform 14 and camera 36 may extend into the line of sight 64 of at least some of the patrons in the seating area 62. However the camera 36, camera platform 14, support cables 16 and tether cable 34 are preferably, relatively compact so as to create an insignificant or extremely limited obstruction to any patron's view of the observed area 60. In addition, the camera platform 14, camera 36 and/or support cables 16 may have a variety of the advertising mediums 32 mounted, secured or projected thereon which would draw additional attention to the advertisement if the support cables 16, tether cable 34, camera platform 14 and/or camera 36 are extend into line of sight 64. In addition, permitting at least the camera 36 to extend into the line of sight 64 of at least some of the patrons in the seating area 62 permits up-close image capture of events occurring in the observed area 60.

In the preferred embodiments, the observed area 64 may be comprised of a field of play including, without limitation, a football field, a basketball court, a soccer field, a baseball field, a hockey rink, a wrestling mat, a theater stage, a border crossing, a swimming pool, a track, a skating rink, a racetrack and/or a convention floor. The image capturing mechanism 10 may be utilized to capture video or still images on any of the listed fields of play and in any of the seating areas 62 that may be associated with the fields of play. Further, the camera 36 may be prompted by the controller 40 to capture video or still images of any one or more persons, such as patrons in the seating area 62 of the arena 28 for later sales or other uses, such as for security purposes.

As the support platform 12 and camera platform 14 move about the venue 28, the camera 36 may be subject to vibrations or other instability that is typically determined to capturing desirable images. In the preferred embodiments, the controller 40, which is preferably comprised of a computerized control system, is utilized to actively control the camera winches 18 and the support cables 16 to stabilize the camera platform 14 relative to the observed area 60. For example, controller 40 may be programmed to limit the speed that the camera winches 18 are designed to move the camera platform 14 relative to the support platform 12. In addition, the controller 40 may be programmed to limit the speed, acceleration and/or deceleration of the support platform 12 as it moves along the transport cable 20. In the preferred embodiments, the controller 40 is able to control movement of the support platform 12 on the transport cable 20 at a rate of approximately 20 miles per hour (20 MPH) and is able to raise and lower the camera platform 14 relative to the support platform 12 at a rate of approximately 10 feet per second (10 ft/s). The controller 40 is not limited to moving the support platform 12 along the transport cable 20 at a rate of twenty miles per hour or the camera platform 14 relative to the support platform 12 at a rate of ten feet per second and may move the support platform 12 and camera platform 14 relative to the venue 27 at nearly any rate. The components of the preferred image capturing mechanism may move about the arena 28 at nearly any speed and may accelerate and/or decelerate and nearly any rate that permits the image capturing mechanism 10 to perform its desired functions and limit damge to the structure of the device.

Referring to FIGS. 1, 2 and 7, in the preferred embodiments, the controller 40 is able to control the camera winches 18 to at least move the camera platform 14 relative to the support platform 12 about the camera axis 30, about a generally horizontal axis 68 and in the vertical direction on the camera axis 30. Accordingly, the controller 40 is able to modify the orientation or line-of-sight of the camera 36 to direct the camera 36 onto various areas in the venue 28 for capturing images.

In the preferred embodiments, the camera 36 is mounted to the camera platform 14 by a camera yoke 70 that permits pivoting about an axis generally parallel to the horizontal axis 68 and pivoting about the camera axis 30. This preferred movement of the camera 36 relative to the camera yoke 70 and camera platform 14 permits directing the line-of-sight of the camera 36 at nearly any portion of the venue 28 or outside the venue 28 that is not obstructed by the image capturing mechanism 10 or structure in the venue 28. Accordingly, the camera 36 is able to capture still and/or video images of nearly anything within its line-of-sight. The movements of the camera 36 relative and on the camera yoke 70, as will be understoodby one having ordinary skill in the art, are preferably directed by the controller 40 through signals sent through the tether 34, directly to the camera 36 utilizing the radio rfequency devices 42, through hard wiring in the support cables 16 or in nearly any other manner that permits directing control signals from the controller 40 to the camera 36 and/or the camera yoke 70.

The image capturing mechanism 10 of the first preferred embodiment is specifically convenient for utilization in the sports arena 28, such as in a basketball arena or at a football field, among others. The preferred image capturing mechanism 10 is able to caspture video and/or still images of game play on the field 54 and is also able to capture still and/or video images of other persons or patrons in the seating area 62. Each of these images may be utilized for later sale to patrons or to media entities to promote or report news on the games. However, as was described above, the rpeferred image capturing mechanism 10 is not limited to use in sporting arenas 28 and my be utilized for security at venues, for similarity capturing images at concerts or for taking video or still images nearly anywhere such images are desired. For example, the images capturing mechanism 10 may be assembled in an open field for a specific event, over a city street for a parade or in nearly any location where an operator intends to capture images.

The support platform 12 is not limited to being mounted to the transport cable 20, the scoreboard 28b or the roof 28a of the venue 28. For example, the support platform 12 may be mounted on cables or rails that extend partially on or around a top portion of the venue 28 (not shown). Such a configuration would allow the camera 36 to be positioned proximate the patrons in the seating area 62 of the venue 28. Such a configuration is also benificial to allow proximity for capturing images of the patrons or to communicate with the patrons through a speaker or an audio receiver to provide two-way communication.

Multiple cameras 36 may be mounted to the camera platform 14 for taking various still or video images of locations in or around the venue 28. The multiple cameras 36 mounted to the camera platform 14 provide additional flexibility for a user in that multiple videos or still photographs in different areas may be taken at the same moment. The controller 40 may be programmed to control the multiple cameras 36 to perform different tasks concurrently or to utilize certain of the multiple cameras 36 daring various extents or different environmental conditions. For example, one of the multiple cameras 36 may be utilized exclusively to capture images of patrons in the seating area 62, another of the cameras 36 may be utilized to capture video images of actions in the observed area 60 and another of the cameras 36 may be utilized during dark or limited lighting conditions.

The speaker and other audio communication mechanisms associated with the preferred image capturing mechanism 10 may also be utilized for security purposes such as to warn any intruders to exit the venue 28. Further, the projector 32 may be utilized to illuminate an area where the motion sensor senses motion when the arena 28 is closed. Such an illumination would likely have a deterrent effect upon intruders. The preferred image capturing mechanism 10 may be used for various security applications including warehouses, shipping terminals, seaports, amusement parks, theaters, public squares, convention centers, cities, atriums, shopping malls, prisons and other like venues 28.

A biometric sensor (not shown) may be associated with the sensor 52 that in communication with the controller 40 directs the user to an individual or object of interest in the venue 28. The biometric sensor preferably has the stability to identify an object or individual of interest in the venue 28. For security purposes, the image capturing mechanism 10 may include lights, microphones, speakers, weapons, crowd control devices or the like and the sensors 52 or other like features or elements that are typically controlled by the controller 40.

The first and second anchors 22, 24 are preferably comprised of a portion of the venue 28 or a pole or truss structure mounted to the venue 28. However, the first and second anchors 22, 24 are not limited to being fixed to or comprised of part of the venue 28 and may be comprised of portable supports, such as cranes, scaffolding or other portable and relatively easily assembled supports that may be erected temporarily in or near a venue 28 for capturing images with the image capturing mechanism 10.

Referring to FIGS. 1 and 3, in the first preferred embodiment, the image capturing mechanism 10 is not limited to mounting of the above-described battery 38, advertising medium 32, controller 40 and radio frequency devices 42 as payload on the support platform 12. For example, the support platform 12 may include spare parts for the image capturing mechanism 10, spare advertising mediums 32 or nearly any other item that may be useful for use with the image capturing mechanism 10 or at the venue 28. These additional items may be stored on thesupport platform 12 for later use with the image capturing mechanism 10 or at the venue 28.

In the preferred embodiment, an operator of the image capturing mechanism 10 is typically located at or near the venue 28 within which the mechanism 10 is being utilized. However, the operator is not limited to being located at or near the venue 28 and may be located in nearly any location where communication between the operator and the controller 40 may be established. The operator may be located in a press box or television studio of the venue 28 or at an off-site studio for monitoring the controller 40. In addition, the controller 40 may be comprised of multiple control units that accomplish various tasks related to the image capturing mechanism 10.

The motion sensor of the sensors 52 or a sensor that follows a specific homing device may be utilized to direct the controller 40 to focus on a specific area in the venue 28. For example, a homing device may be positioned in a ball being used for gameplay at the venue 28 such that the camera 36 is constantly focusing in the ball or the multiple cameras 36 at a specific venue are all focusing on the homing device, for example the homing device in the ball. Further, one camera 36 of multiple cameras 36 mounted to the same camera platform 14 may be independently controlled by an operator or may be directed by the controller 40 to capture images of patrons in the seating area 62 during game play.

It is desirable to stabilize the camera 36 and/or the camera platform 14 as the image capturing mechanism 10 moves about the venue 28 so that video or still images from the camera 36 do not show unwanted motion, whether it is low frequency (such as a slow ship-like movement resulting in an undesirable slowly moving horizon) or high frequency (such as video from a moving vehicle on a rough road). As was described above, the controller 40 may provide automatic controls to proivide stability to the camera 36 or camera platform 14, may after the image to give the appearance of stability in the captured image or the stracture of the image capturing mechanism 10 may be configured to promote stability of the camera platform 14 and the camera 36. For example, the controller 40 may be programmed to maintain the camera 36 and resulting captured images in a relatively stable state, even in the presense of disturbances such as wind or movement of the stadium or venue 28.

In the preferred embodiments, the support cables 16 are relatively thin and most preferably are approximately one millimiter (1 mm) or less in diameter. The support cables 16 may be constructed of a clear monofilament line, similar to that used as fishing line or may be comprised of fiber optic cables to transmit signals to and from the camera platform 14, the controller 40 or any other payload on the support platform 12 or related to the image capturing mechanism 10. The relatively thin or partially transparent support cables 16 limit the obstructions to spectators in the seating area 62, which is desirable. The relatively thin support cables 16 also limit shadows that may result from the support cables 16 being positioned between the sun and/or lights in the venue 28 and the observed area 60 or the seating area 62.

Referring to FIGS. 1-4, the preferred configuration of the support platform 12, camera platform 14 and the support cables 16 may be referred to as a Stewart platform. The Stewart platform configuration provides the at least six (6) preferred, independent support cables 16 that are used to support the camera platform 14.

The controller 40 is preferably designed such that the camera 36 and camera platform 14 do not extend into contact with individuals that may be positioned in the observed area 60 or within the seating area 62 of venue 28. For example, the controller 40 may control the camera winches 18 and transport winches 26 such that the camera 36 and camera platform 14 do not come any closer than seven feet ((7′) from the receiving surface 54, the seating area 62 or any portion of the venue 28 where patrons may be positioned. Further, the tether 34 may be sized such that even if the camera winches 18 were able to release the camera platform 14 and camera 36 to positions closer to the receiveing surface 54 that the above-described preferred distancxe, the tether cable 34 would limit movement of the camera platform 14 and/or camera 36 in its movement to a predetermined distance from any individuals in the venue 28. The camera 36 and camera platform 14 are not limited to being spaced from the observed area 60, the seating area 62, the patrons or other portions of the venue 28 the above-described distances and my be space from this items nearly any distance or may be permitted to contact any or all of these items, as would be determined by one having ordinary skill in the art based upon the particular application.

Referring to FIGS. 1-8, the image capturing mechanism 10 of the preferred embodiments may be located in or outside the venue 28 and multiple platforms 12, 14 and cables 16, 20, 34 may be utilized to provide a wide variety of coverage in or outside the venue 28. For example, a single transport cable 20 may extend over the center of a playing field to provide an extensive and exciting view of action of the observed area 60 and/or in the seating area 62. Alternatively, additional or individual transport cables 20 may be positioned diagonally, along an end zone, along an end line, along a sideline, along a baseline or around a track of the venue 28 to provide a variety of views of action in the observed area 60 or within the seating area 62. The individual cameras 36 associated with the image capturing mechanism or mechanisms 10 nay be operated by a single operator or by multiple operators and individual cameras 36 mounted on the same camera platform 14 may be operated by different operators. Further, as was described above, certain of the cameras 36 by the controller 40 is typically referred to as the camera 36 being “slaved”.

Referring to FIGS. 1, 3 and 4, the tether 34 may be biased into tension when attached to the camera platform 14. For example, the tether 34 may be mounted to a take up reel (not shown) that is biased to place the tether 34 in tension or may be attached to a spring (not shown) that maintains the tether 34 in tension relative to the camera platform 14. Maintaining the tether 34 in tension limits potential tangling of the tether 34 with other components of the image capturing mechanism 10, may provide a fail-safe cable if other portions of the image capturing mechanism 10 fail and may provide convenient storage for the tether 34. Further, maintaining the tether 34 in tension may provide additional stability to the camera platform 14 and camera 36.

Referring to FIGS. 1-4, in the first preferred embodiment, the six camera winches 18 are utilized to move the camera platform 14 and camera 36 relative to the support platform 12. However, the six support cables 16 may also be used with a single camera winch (not shown) or with nearly any number of winches between the maximum number of support cables 16 and one camera winch to control movement of the camera platform 14 relative to the camera 36. For example, a single camera winch 18 may be mounted in the center of the support platform 12 and each of the six support cables 16 may be attached to the individual camera winch 18. In such a configuration, actuation of the single camera winch 18 in one directioin causes the camera platform 14 and camera 36 to move toward the support platform 12 and actuationof the camera winch 18 to operate in the opposite direction causes the camera platform 14 and camera 36 to move away from the support platform 12. However, utilization of the six camera winches 18 with the six support cables 16 permits alternative orientstions of the camera platform 14 and camera 36 relative to the support platform 12 and provides additional flexibility for positioning the camera 36, as would be understood by one having ordinary skill in the art.

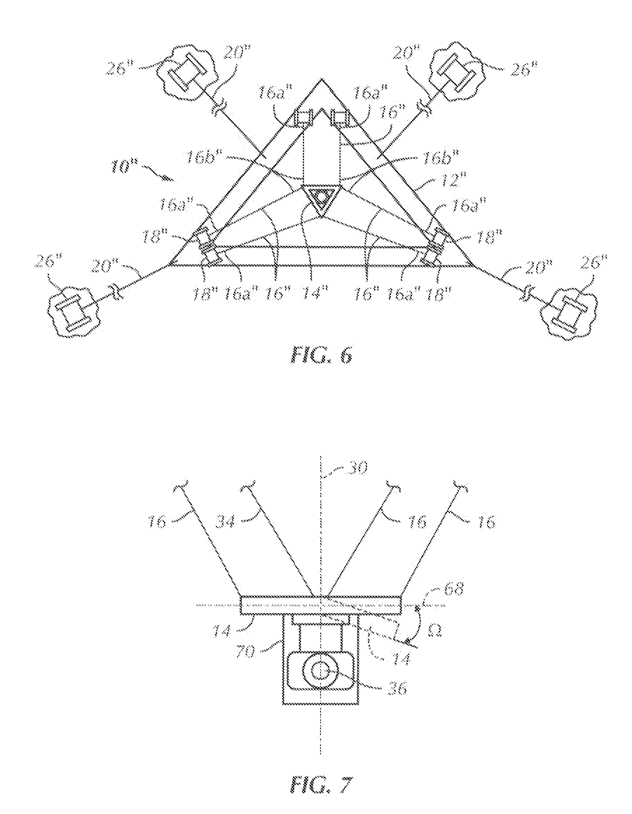

Referring to FIGS. 3 and 6, in a third preferred embodiment of the image capturing mechanism 10″, the support platform 12″, support cables 16″ and camera platform 14″ are mounted to move about a venue 28 on four transparent cables 20″ that are mounted at various, preferably relatively high locations 80 in the venue to four transport winches 26″. In this configuration, the transport winches 26″ and the transport cables 20″ function in a similar manner to the device disclosed in U.S. Pat. No. 4,710,819. However, the preferred structure and function if the support platform 12″, camera platform 14″ and associated support cables 16″ of the image capturing mechanism 10″ of the third preferred embodiment of the present invention are incorporated.

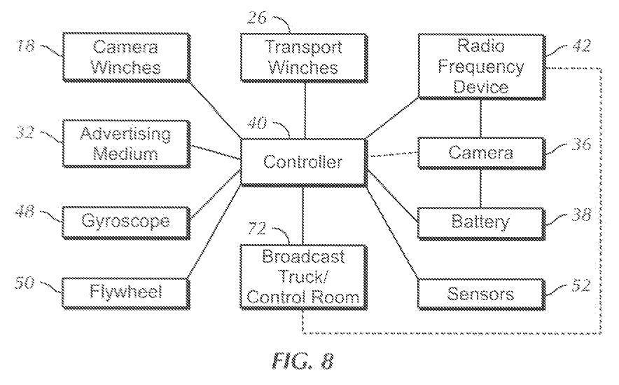

In operation, the image capturing mechanisms 10, 10′, 10″ are secured relative to or in the venue 28 or at an alternative location and the support platform 12 is positioned over at least a portion of the observed area 60. The camera platform 14 is moved relative to the support platform 12 into an image capturing position, which may be nearly anywhere within the zone of movement of the camera 36. For example, the transport winches 26 may be actuated to move the support platform 12 nearly anywhere along the transport cable 20, the camera winches 18 may be actuated to move the camera platform 14 and camera 36 toward and away from the support platform 12 and the camera 36 may be tilted and/or pivoted using the camera yoke 70 to direct the camera 36 toward a target area. Further, the various camera winches 18 may be actuated different amounts such that the camera platform 14 defines a camera pitch angle Ω (FIG. 7) relative to the horizontal position. The camera 36 is focused on the target and an image of the target is captured utilizing the camera 36. The captured image is communicated to the controller 40 and the image is stored at the controller 40. The controller 40 may transmit the image to a control studio for distribution or for alternative viewing or other uses.

The camera 36 may specifically be focused on a field target area on the receiving surface 54 in the venue 28 and an alternative camera 36 may be focused on a seating target area in the seating area 62. Still images utilizing a still camera 36 are typically captured of the patrons in the seating area 62; however, such captured images are not limited to still inages and may be comprised of video images. In addition, video images are preferably captured of the observed area 60 by a video camera 36 during game play, but are likewise not so limited.

Referring back to FIG. 8, the stored images in the controller 40 may be transmitted through hard wiring to a broadcast truck/control room 72 or utilizing the radio requency devices 42 or some other communication system or equipment. The broadcast truck/control room 72 may then edit the images, directly transmit the images for distribution, store the images or otherwise manipulate the images for later or immediate use.

Referring to FIGS. 1-4 and 8, for example, if the image capturing mechanism 10 is mounted in a sports arena, the captured images from a game or practice may be stored in the controller 40 or in the broadcast truck/control room 72 for later sorting and viewing by a coach, players, patrons or nearly anyone else who is able to view the images. The images may be sorted by identifiable criteria such as down and distance, tendencies in certain game situations, player-specific events, specific players in practice or games and other related criteria. The saved images and/or videos may then be utilized by the coach as a teaching tool for individual players. If utilized by a participant in an event at the venue 28, a player may select stored images and transmit the images directly to coaches and/or scouts. The players may also edit the captured images stored in the controller 40 and/or broadcast truck/control room 72 into a convenient package for a targeted party. Further, participants or patrons at the event at the venue 28 may search, edit and package specific images from an event for personal use. An institution may also collect, edit and transmit stored images from a specific event for later broadcast or sale.

Referring to FIGS. 1, 2 and 4, the image capturing mechanism 10, 10′, 10″ of the preferred embodiments utilizing the advertising medium 32 are also particularly adaptable as flying billboards at a venue 28. The advertising medium 32 may be relatively flexible or adaptable including banners mounted to vrious portions of the image capturing mechanism 10, backlit signage, images projected onto the venue 28 using the projector 32, electronic signs including liquid crystal displays (LCD), plasma video screens, an array of light emitting diodes (LED), fluorescent signage, neon signage or other like signage, video screens mounted to the components of the image capturing mechanism 10 or advertising mediums 32 specifically directed to the image capturing mechanism itself.

Referring to FIGS. 3 and 4, in the preferred embodiments, the transparent winches 26 are actuated to move the support platform 12, support cable 16, camera platform 14 and camera 36 to a position relative to the receiving surface 54 such that a technician is able to perform maintenance, modify the advertising madium 32, add additional or remove cameras 36 from the camera platform 14 or otherwise perform tasks related to the image capturing mechanism 10 without climbing into high reaches of the venue 28. Such maintenance on the preferred image capturing mechanism 10 improves safety for the technician and generally simplifies routine maintenance and modification of the image capturing mechanism 10.

The present application is related to copending U.S. patet application Ser. No. ______ (related application), titled “Event Participating Image Locating, Retrieving, Editing and Printing System” and filed Sep. 7, 2006. The related application is directed to various methods for utilizing and controlling an image capturing mechanism similar to the preferred image capturing mechanisms 10, 10′, 10″ described herein to capture, edit, print and distribute captured images and to provide features for consumers of the captured images. The related application is incorporated herein by reference in its entirety.

It will be appriciated by those skilled in the art that changes could be made to the embodiments described above without departing from the board inventive concept thereof. For example, the preferred embodiments of the image capturing mechanism of the present invention may be utilized for several additional applications than capturing video and still images at sporting events, such as providing security, video and still images at conventions, aquatic observation and monitoring of hazardous clean-up sites or other like uses. It is understood, therefore, thus this invention is not limited to the particular embodiments disclosed, but is intended to cover modifications within the spirit and scope of the present invention as defined by the appended claims.

We claim:

1. An image capturing mechanism for capturing an image of a target, the image capturing mechanism comprising:
a support platform;
a camera platform suspended from the support platform by a support cable, a first end of the support cable mounted to the support platform and a second end of the support cable mounted to the camera platform;
a camera mounted to the camera platform; and
a stabilization mechanism associated with the camera to stabilize at least one of the captured images and the camera.

2. The image capturing mechanism of claim 1 further comprising:
a transport cable mounted to the support platform, the transport cable having a third end and a fourth end;
a first anchor, the third end mounted to the first anchor; and
a second anchor, the fourth end mounted to the second anchor, the support platform being movable relative to the first and second anchors.

3. The image capturing mechanism of claim 1 wherein the support cable is comprised of a plurality of support cables, the plurality of support cables being comprised of first, second, third, fourth, fifth and sixth support cables, the support cables being mounted to the support platform by first, second, third, fourth, fifth and sixth camera winches, respectively.

4. The image capturing mechanism of claim 1 further comprising:
an advertising medium mounted to one of the camera platform and the support platform.

5. The image capturing mechanism of claim 4 wherein the advertising medium is comprised of a banner secured to at least one of the camera platform and the support platform, the banner having a printed advertisement thereon.

6. The image capturing mechanism of claim 1 further comprising:
a teather cable extending from the support platform to the camera.

7. The image capturing mechanism of claim 6 wherein the tether cable is comprised of a fiber optic cable.

8. The image capturing mechanism of claim 1 further comprising:
a plurality of camera winches mounted to the support platform, the support cable being comprised of a plurality of support cables, each of the plurality of camera winches being associated with one of the plurality of support cables, the camera winches operable to move the camera platform relative to the support platform; and
a controller in communication with the camera winches.

9. The image capturing mechanism of claim 8 further comprising:
a first transport cabl;e and a second transport cable mounted to the support platform, the support platform movable along the first and second transport cables; and
a first spreader bar and a second spreader bar mounted to the first and second transport cables, the first and second spreader bars having a spreader length, the first and second spreader bars separating the first and second cables.

10. The image capturing mechanism of claim 8 further comprising:
a battery mounted to the support platform that provides power to at least the camera;
a controller mounted to the support platform that at least stores images captured by the camera; and
radio frequency devices mounted to the support platform for transmitting at least one of images from the camera to the controller, command signals from the controller to the camera and command signals from the controller to the camera winches.

11. The image capturing mechanism of claim 1 wherein the support platform and the camera platform are coaxially mounted on a camera axis, the support cable being comprised of a plurality of support cables, each of the plurality of support cables defining a support angle relative to the camera axis, the stabilization mechanism being comprised of the plurality of support cables.

12. The image capturing mechanism of claim 1 further comprising:
a plurality of camera winches mounted to the support platform wherein the support platform is comprised of a portion of a venue.

13. The image capturing mechanism of claim 1 further comprising:
a controller; and
a projector mounted to one of the support platform and the camera platform, the projector being in communication with the controller, the projector directing an advertising symbol onto a receiving surface beneath the camera platform.

14. The image capturing mechanism of claim 1 wherein the support cable is comprised of a plurality of support cables, the stabilization mechanism being comprised of at least one of the plurality of support cables extending from the support platform at a support angle, dampeners mounted to the plurality of support cables, a controller that controls movement of the camera platform relative to the support platform, a gyroscope and a flywheel.

15. The image capturing mechanism of claim 1 further comprising:
a camera wich mounted to the support platform, the first end of the at least one support cable being mounted to the camera winch; and
a controller in communication with the camera winch and the camera platform, the stability mechanism being comprised of the controller actively controlling the camera winch and the at least one support cable to stabilize the camera platform relative to the observed area.

16. The image capturing mechanism of claim 1 wherein the controller controls the camera winches to at least one of move the camera platform relative to the support platform about a camera axis and about a generally horizontal camera axis.

17. An image capturing mechanism for capturing images ina venue having an obswerved area, a seating area and a line of sight, the image capturing mechanism comprising:
a support platform movable relative to the venue, the support platform being positioned outside of the line of sight;
at least one camera winch mounted to the support platform;
a camera platform suspended from the support platform by at least one support cable, the at least one support cable secured to the at least one camera winch, the camera platform being movable at least in a vertical direction relative to the support platform through actuation of the at least one camera winch;
a camera mounted to the camera platform; and
an advertising medium mounted to at least one of the camera platform and the support platform.

18. The image capturing mechanism of claim 17 wherein the advertising medium is comprised of a banner secured to one of the camera platform and the support platform having a printed advertisement thereon.

19. The image capturing mechanism of claim 17 wherein the advertising medium is comprised of a message board that permits continuous modification of an advertisement on the advertising medium, a controller in communication with the advertising medium to modify the advertisement at predetermined tme periods.

20. An image capturing mechanism for capturing images in an arena having a seating area and an observed area, a line of sight being defined between the seating area and the observed area, the image capturing mechanism comprising:
a support platform movable relative to the arena, the support platform being movable outside of the line of sight;
a camera platform suspended from the support platform by a plurality of support cables, the camera platform being movable relative to the support platform; and
a camera movably mounted to the camera platform for capturing images of at least one of the seating area and the observed area.

21. The image captiring mechanism of claim 20 further comprising:
a controller in communication with the support platform, the camera platform and the camera.

22. The image capturing mechanism of claim 21 further comprising:
at least one sensor in communication with the controller.

23. The image capturing mechanism of claim 22 wherein the at least one sensor is comprised of a motion sensor, the controller directing the camera to focus on a motion area based upon an indication of movement in the motion area from the motion sensor.

24. The image capturing mechanism of claim 20 wherein the observed area is comprised of a field of play.

25. A method of capturing images in an arena including a seating area and an observed area with an image capturing mechanism including a supportt platform, a camera platform suspended from the support platform by a plurality of support cables, a controller and a camera that is movable relative to the arena, the method comprising the steps of:
a) positioning the support platform over at least a portion of the observed area;
b) moving the camera platform relative to the support platform into an image capturing position;
c) moving the camera relative to the camera platform to direct the camera onto a target, the camera platform moving from a generally horizontal position relative to the observed area to a position where the camera platform defines a camera pitch angle relative the horizontal position;
d) focusing the camera on the target;
e) capturing an image of the target utilizing the camera and communicating the captured image to the controller; and
f) storing the image.

26. The method of claim 25 wherein the support platform is positioned in step (a) by moving the support platform along at least one transport cable mounted to the arena, the transport cable having a third end and a fourth end, the support platform movable between a position proximate the third end and a position proximate the fourth end.

27. The method of claim 25 wherein the camera is comprised of a video camera and the camera captures video images in step (e).

28. The method of claim 25 wherein the camera is comprised of a video camera and a still camera, the method comprising the further steps of:
d1) focusing the video camera on a field target area on the observed area in step (d);
d2) focusing the still camera on a seating target area in step (d);
e1) capturing a video image of the field target area utilizing the video camera in step (e); and
e2) capturing a still image of spectators in the seating target area in step 9e).

29. The method of claim 25 wherein the controller is in communication with a motion sensor, the controller receiving a motion signal from the motion sensor prior to step (b) and the target in step (d) being a motion area defined by an area where the motion sensor senses motion in the arena.

30. The method of claim 25 comprising the further step of:
g) transmitting the stored images of step (f) to at least one of a broadcast truck, a television, and a secondary controller.

31. An advertising mechanism mounted within a venue for imarting advertising to indivioduals at the venue, the advertising mechanism comprising:
a first anchor nounted to the venue;
a second anchor mounted to the venue;
a transport cable having a first end and a second end, the first end being secured to the first anchor and the second end being secured to the second anchor;
a support platform movably mounted to the transport cable; and
an advertising medium mounted to the support platform such that the individuals are attached to the support platform and advertising medium as the support platform moves relative to the transport cable.

32. The advertising mechanism of claim 31 further comprising:
a camera platform suspended from the support platform by a plurality of support cables, the camera platform movable to the support platform; and
a camera mounted to the camera platform.

33. The advertising mechanism of claim 32 further comprising:
a plurality of camera winches mounted to the support platform associated with the plurality of support cables; and
a controller being in communication with the camera winches and the camera, the controller controlling the camera winches to stabilize the camera relative to an observed area and controlling the camera to capture images of the observed area.

34. An image capturing mechanism for capturing an image of a target, the image capturing mechanism comprising:
a support platform;
a camera platform suspended from the support platform by a plurality of support cables. a first end of each of the support cables mounted to the support platform and a second end of each of the support cables mounted to the camera platform; and
a camera mounted to the camera platform, the support platform and the camera platform being coaxially mounted on a camera axis, each of the plurality of support cables defining a support angle relative to the camera axis.

35. The image capturing mechanism of claim 34 further comprising:
a controller in communication with the camera, the controller transmitting control signals to the camera and the camera transmitting captured images to the controller.

36. The image capturing mechanism of claim 35 further comprising:
a plurality of camera winches mounted to the support platform, each of the plurality of camera winches associated with one of the plurality of support cables, the plurality of camera winches being in communication with the controller, the controller providing operating signals to the plurality of camera winches to stabilize camera relative to the target.

37. The image capturing mechanism of claim 34 further comprising:
a transport cable mounted to the support platform, the transport cable having a third end and a fourth end;
a first anchor, the third end mounted to the first anchor; and
a second anchor, the fourth end mounted to the second anchor, the support platform being movable relative to the first and second anchors.

38. The image capturing mechanism of claim 37 further comprising:
a transport winch mounted to the support platform and the transport cable; and
a controller being in communication with the transport winch, the controller providing transport signals to the transport winch to move the support platform along the transport cable.
